(19) United States
(12) Patent Application Publication
(10) Pub. No.: US 2023/0237402 A1
(43) Pub. Date: Jul. 27, 2023

(54) METHODS, SYSTEMS, APPARATUS, AND ARTICLES OF MANUFACTURE TO ENABLE MANUAL USER INTERACTION WITH AUTOMATED PROCESSES

(71) Applicant: VMware, Inc., Palo Alto, CA (US)

(72) Inventors: Diana Dimitrova Kovacheva, Sofia (BG); Yanitsa Dimitrova Spasova, Sofia (BG); Nikola Anastasov Arnaudov, Sofia (BG)

(21) Appl. No.: 17/581,128

(22) Filed: Jan. 21, 2022

(51) Int. Cl. G06Q 10/06; G06F 9/54; G06F 9/451; G06Q 50/04

(52) U.S. Cl. CPC G06Q 10/0633; G06F 9/547; G06F 9/451; G06Q 50/04

(57) ABSTRACT

Methods, apparatus, systems, and articles of manufacture are disclosed to enable manual user interaction (MUI) with automated processes. An example apparatus includes blueprint service circuitry to monitor a status of the workflow, the workflow executed by an orchestrator. The example apparatus also includes MUI form service circuitry to, in response to the status indicating that the workflow requires an MUI to continue execution, cause a user interface to provide an approving entity with access to an MUI form associated with the MUI, and record one or more responses to the MUI form from the approving entity. Additionally, the example apparatus includes orchestrator gateway service circuitry to send the one or more responses to the orchestrator to enable the orchestrator to continue execution of the workflow.

### FIELD OF THE DISCLOSURE

This disclosure relates generally to cloud computing and, more particularly, to methods, systems, apparatus, and articles of manufacture to enable manual user interaction with automated processes.

### BACKGROUND

Virtualizing computer systems provides benefits such as the ability to execute multiple computer systems on a single hardware computer, replicating computer systems, moving computer systems among multiple hardware computers, and so forth. Infrastructure-as-a-Service (IaaS) generally describes a suite of technologies provided by a service provider as an integrated solution to allow for elastic creation of a virtualized, networked, and pooled computing platform (sometimes referred to as a cloud computing platform). Enterprises may use IaaS as a business-internal organizational cloud computing platform (sometimes referred to as a private cloud) that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale and at a faster pace than ever before.

Cloud computing environments may include many instances of processor circuitry (e.g., servers). The processor circuitry may be installed in standardized frames, known as racks, which provide efficient use of floor space by allowing the processor circuitry to be stacked vertically. The racks may additionally include other components of a cloud computing environment such as storage devices, networking devices (e.g., switches), etc.

### BRIEF DESCRIPTION OF THE DRAWINGS

FIG. 1 is an example architecture in which an example virtual imaging appliance (VIA) is utilized to configure and deploy an example virtual server rack.

FIG. 2 is a sequence diagram illustrating example operations of the example operations and management (OAM) layer of FIG. 1.

FIG. 3 is a block diagram of the vRealize Automation® (vRA) service of FIGS. 1 and/or 2 to enable manual user interaction with automated processes.

FIG. 4 is a flowchart representative of example machine readable instructions and/or example operations that may be executed and/or instantiated by processor circuitry to implement the vRA service of FIGS. 1, 2, and/or 3 to enable manual user interaction with automated processes.

FIG. 5 is a flowchart representative of additional example machine readable instructions and/or example operations that may be executed and/or instantiated by processor circuitry to implement the vRA service of FIGS. 1, 2, and/or 3 to enable manual user interaction with automated processes.

FIG. 6 is a block diagram of an example processing platform including processor circuitry structured to execute the example machine readable instructions and/or the example operations of FIGS. 4 and/or 5 to implement the vRA service of FIGS. 1, 2, and/or 3.

FIG. 7 is a block diagram of an example implementation of the processor circuitry of FIG. 6.

FIG. 8 is a block diagram of another example implementation of the processor circuitry of FIG. 6.

FIG. 9 is a block diagram of an example software distribution platform (e.g., one or more servers) to distribute software (e.g., software corresponding to the example machine readable instructions of FIGS. 4 and/or 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s). In some examples, an ASIC may be referred to as Application Specific Integrated Circuitry.

### DETAILED DESCRIPTION

Cloud computing comprises a plurality of key characteristics. First, cloud computing allows software to access APIs that enable machines to interact with cloud software in the same way that a traditional user interface (e.g., a computer desktop) facilitates interaction between humans and computers. Second, cloud computing enables businesses or large organizations to allocate expenses on an operational basis (e.g., on a per-use basis) rather than a capital basis (e.g., equipment purchases). Costs of operating a business using, for example, cloud computing, are not significantly based on purchasing fixed assets but are instead more so based on maintenance of existing infrastructure. Third, cloud computing enables convenient maintenance procedures because computing applications are not installed on individual users' computers but are instead installed at one or more servers forming the cloud service. As such, software can be accessed and maintained from different places (e.g., from an example virtual cloud).

Information technology (IT) refers to the application of computers and telecommunications equipment to store, retrieve, transmit and/or manipulate data, often in the context of a business or other enterprise. For example, databases store large amounts of data to enable quick and accurate information storage and retrieval. IT service management refers to the activities (e.g., directed by policies, organized, and structured in processes and supporting procedures) that are performed by an organization or part of an organization to plan, deliver, operate, and control IT services that meet the needs of customers. IT management may, for example, be performed by an IT service provider through a mix of people, processes, and information technology. In some examples, an IT system administrator is a person responsible for the upkeep, configuration, and reliable operation of computer systems, especially multi-user computers, such as servers that seek to ensure uptime, performance, resources, and security of computers meet user needs. For example, an IT system administrator may acquire, install and/or upgrade computer components and software, provide routine automation, maintain security policies, troubleshoot technical issues, and provide assistance to users in an IT network. An enlarged user group and a large number of service requests can quickly overload system administrators and prevent immediate troubleshooting and service provisioning.

Cloud provisioning refers to the allocation of cloud provider resources to a customer when a cloud provider accepts a request from a customer. For example, the cloud provider creates a corresponding number of virtual machines and allocates resources (e.g., application servers, load balancers, network storage, databases, firewalls, IP addresses, virtual or local area networks, etc.) to support application operation. In some examples, a virtual machine is an emulation of a particular computer system that operates based on a particular computer architecture, while functioning as a real or hypothetical computer. Virtual machine implementations may involve specialized hardware, software, and/or a combination of both. Example virtual machines allow multiple operating system (OS) environments to co-exist on the same primary hard drive and support application provisioning. Before example virtual machines and/or resources are provisioned to users, cloud operators and/or administrators determine which virtual machines and/or resources should be provisioned to support applications requested by users.

Virtual cloud computing uses networks of remote servers, computers, and/or computer programs to manage access to centralized resources and/or services, to store, to manage, and/or to process data. Virtual cloud computing enables businesses and large organizations to scale up IT requirements as demand or business needs increase. Virtual cloud computing relies on sharing resources to achieve coherence and economies of scale over a network. In some example cloud computing environments, an organization may store sensitive client data in-house on a private cloud application, but interconnect to a business intelligence application provided on a public cloud software service. Such example cloud computing environments are sometimes referred to as hybrid cloud computing environments or hybrid clouds. In such examples, a cloud may extend capabilities of an enterprise, for example, to deliver a specific business service through the addition of externally available public cloud services. In some examples, cloud computing permits multiple users to access a single server to retrieve and/or update data without purchasing licenses for different applications.

Prior to cloud computing, as resources and data increased based on increased business needs or demands, computing systems required the addition of significantly more data storage infrastructure. Virtual cloud computing accommodates increases in workflows and data storage demands without significant efforts of adding more hardware infrastructure. For example, businesses may scale data storage allocation in a cloud without purchasing additional infrastructure.

Some cloud computing environments allow users (e.g., IT system administrator, a data center operator, an enterprise employee, etc.) to automate complex data center infrastructure tasks. For example, the vRealize Automation® (vRA) service developed and sold by VMware, Inc. provides a modern infrastructure automation platform. Such automation allows for increased scalability, speed, flexibility, and reliability by reducing the complexity associated with managing a cloud computing environment.

While a user may desire complete automation for some tasks, a user may desire other tasks to involve some user interaction. For example, before a service is deployed, an IT system administrator and/or other user may desire to have some level of input as to the configuration parameters of the resource so as to ensure that certain conditions are met. For example, an IT system administrator may desire to evaluate the resource allocation that would be required to implement the requested service to ensure that an overall deployment managed by the IT system administrator is not overburdened. Additionally or alternatively, for example, a business management employee may desire to evaluate the monetary cost associated with deploying the requested service to ensure that capital expenditure associated with the overall deployment does not exceed a predefined amount. Accordingly, it would be beneficial to customers of cloud service providers to exercise some level of user interaction with automated processes as needed.

Examples disclosed herein include methods, systems, apparatus, and articles of manufacture to enable manual user interaction with automated processes. Examples disclosed herein provide users that develop automated processes defined by their own custom logic to implement user interaction with those automated processes. Examples disclosed herein allow for users to integrate one or more approval (e.g., a single approval and/or multiple approvals) requests into custom automated processes.

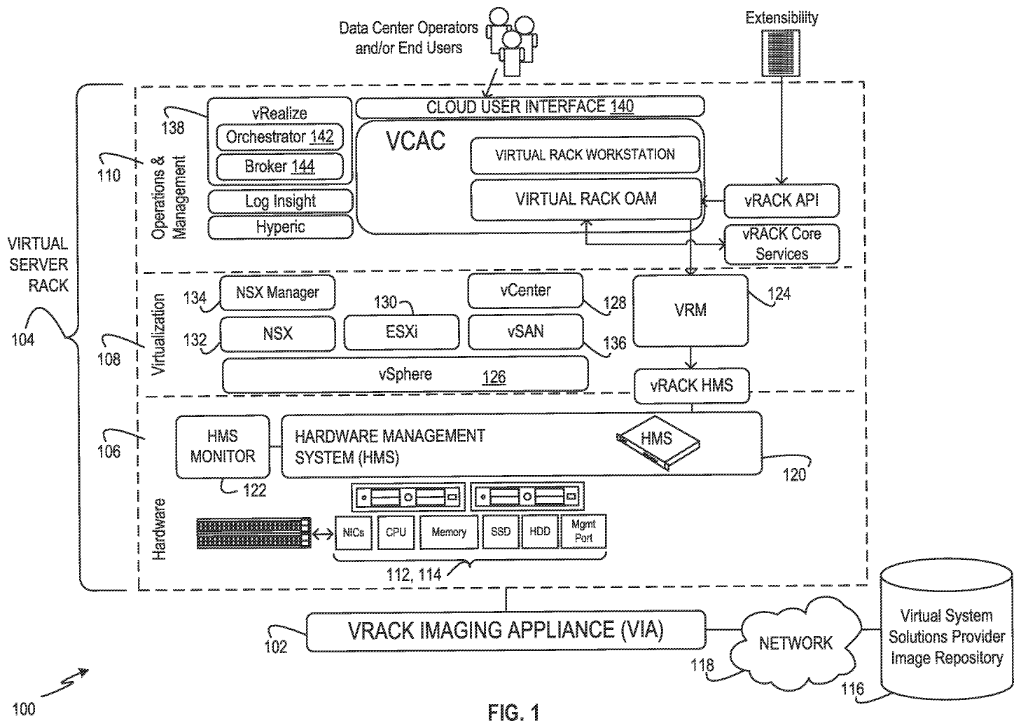

FIG. 1 is an example architecture 100 in which an example virtual imaging appliance (VIA) 102 is utilized to configure and deploy an example virtual server rack 104. The example architecture 100 of FIG. 1 includes a hardware layer 106, a virtualization layer 108, and an operations and management (OAM) layer 110. In the illustrated example of FIG. 1, the hardware layer 106, the virtualization layer 108, and the OAM layer 110 are included in the example virtual server rack 104. The virtual server rack 104 of the illustrated example is deployed on one or more example physical racks.

Example physical racks are a combination of computing hardware and installed software that may be utilized by a customer to create and/or add to a virtual computing environment. For example, the physical racks may include processor circuitry (e.g., multiple blade servers), network switches to interconnect the processor circuitry and to connect the physical racks with other computing units (e.g., other physical racks in a network environment such as a cloud computing environment), and/or data storage units (e.g., network attached storage, storage area network hardware, etc.). The example physical racks are prepared by a system integrator in a partially configured state to enable the computing devices to be rapidly deployed at a customer location (e.g., in less than 2 hours). For example, the system integrator may install OSs, drivers, operations software, management software, etc. The installed components may be configured with some system details (e.g., system details to facilitate intercommunication between the components of two or more physical racks) and/or may be prepared with software to collect further information from the customer when the virtual server rack is installed and first powered on by the customer.

In examples disclosed herein, the one or more physical racks on which the virtual server rack 104 is deployed may be disposed in the same geographic location or in diverse geographic locations. For example, in one implementation, the one or more physical racks on which the virtual server rack 104 is deployed are disposed in the same geographic location (e.g., the same data center). Alternatively, in another example implementation, the one or more physical racks on which the virtual server rack 104 is deployed are disposed in two or more geographic locations (e.g., a first data center located at a first geographic location and a second data center located at a second geographic location different than the first geographic location). Additionally, in any example disclosed herein, some components of the virtual server rack 104 may be deployed on a first physical rack while other components of the virtual server rack 104 may be deployed on a second physical rack different from the first physical rack.

Additionally, in examples disclosed herein, the one or more physical racks on which the virtual server rack 104 is deployed may be a part of a private cloud, a public cloud, or a hybrid cloud. For example, the one or more physical racks on which the virtual server rack 104 is deployed may be resources that are on the premises of an enterprise (e.g., on-premises resources). On-premises resources include internal physical resources (e.g., processor circuitry, networking circuitry, storage devices, etc.) and/or internal virtual resources (e.g., supported hypervisors and associated management tools). In additional or alternative examples, the one or more physical racks on which the virtual server rack 104 is deployed may be resources that are off the premises of an enterprise (e.g., off-premises resources). Off-premises resources includes external physical resources (e.g., processor circuitry, networking circuitry, storage devices, etc.) and/or external cloud resources (e.g., supported cloud providers and associated APIs).

The example virtual server rack 104 is configured to configure example physical hardware resources 112, 114 (e.g., physical hardware resources of the one or more physical racks), to virtualize the physical hardware resources 112, 114 into virtual resources, to provision virtual resources for use in providing cloud-based services, and to maintain the physical hardware resources 112, 114 and the virtual resources. In the example of FIG. 1, the VIA 102 communicates with the hardware layer 106 to store one or more OSs and software images in memory of the hardware layer 106 for use in initializing physical resources needed to configure the virtual server rack 104. In the illustrated example of FIG. 1, the VIA 102 retrieves the one or more OSs and software images from a virtual system solutions provider image repository 116 via an example network 118 (e.g., the Internet). For example, the VIA 102 configures new physical racks for use as virtual server racks (e.g., the virtual server rack 104). That is, whenever a system integrator wishes to configure new hardware (e.g., a new physical rack) for use as a virtual server rack, the system integrator connects the VIA 102 to the new hardware, and the VIA 102 communicates with the virtual system provider image repository 116 to retrieve one or more OSs and/or software images needed to configure the new hardware for use as a virtual server rack. In such an example, the one or more OSs and/or software images located in the virtual system provider image repository 116 are configured to provide the system integrator with flexibility in selecting to obtain hardware from any of a number of hardware manufacturers. As such, end users can source hardware from multiple hardware manufacturers without needing to develop custom software solutions for each hardware manufacturer. Further details of the example VIA 102 are disclosed in U.S. Patent Application Publication No. 2016/0013974, filed on Jun. 26, 2015, and titled “Methods and Apparatus for Rack Deployments for Virtual Computing Environments,” which is hereby incorporated herein by reference in its entirety.

The example hardware layer 106 of FIG. 1 includes an example hardware management system (HMS) 120 that interfaces with the physical hardware resources 112, 114 (e.g., processor circuitry, network interface circuitry, servers, switches, storage devices, peripherals, power supplies, etc.). The HMS 120 is configured to manage individual hardware nodes such as different ones of the physical hardware resources 112, 114. For example, managing of the hardware nodes involves discovering nodes, bootstrapping nodes, resetting nodes, processing hardware events (e.g., alarms, sensor data threshold triggers) and state changes, exposing hardware events and state changes to other resources and a stack of the virtual server rack 104 in a hardware-independent manner. The HMS 120 also supports rack-level boot-up sequencing of the physical hardware resources 112, 114 and provides services such as secure resets, remote resets, and/or hard resets of the physical hardware resources 112, 114.

In the illustrated example of FIG. 1, the hardware layer 106 includes an example HMS monitor 122 to monitor the operational status and health of the HMS 120. The example HMS monitor 122 is an external entity outside of the context of the HMS 120 that detects and remediates failures in the HMS 120. That is, the HMS monitor 122 is a process that runs outside the HMS daemon to monitor the HMS daemon. For example, the HMS monitor 122 can run alongside the HMS 120 in the same management switch as the HMS 120.

The example virtualization layer 108 includes an example virtual rack manager (VRM) 124. The example VRM 124 communicates with the HMS 120 to manage the physical hardware resources 112, 114. The example VRM 124 creates the example virtual server rack 104 out of underlying physical hardware resources 112, 114 that may span one or more physical racks (or smaller units such as a hyper-appliance or half rack) and handles physical management of those resources. The example VRM 124 uses the virtual server rack 104 as a basis of aggregation to create and provide operational views, handle fault domains, and scale to accommodate workload profiles. The example VRM 124 keeps track of available capacity in the virtual server rack 104, maintains a view of a logical pool of virtual resources throughout the SDDC life-cycle, and translates logical resource provisioning to allocation of physical hardware resources 112, 114. The example VRM 124 interfaces with components of a virtual system solutions provider, such as an example VMware vSphere® virtualization infrastructure components suite 126, an example VMware vCenter® virtual infrastructure server 128, an example ESXi™ hypervisor component 130, an example VMware NSX® network virtualization platform 132 (e.g., a network virtualization component or a network virtualizer), an example VMware NSX® network virtualization manager 134, and an example VMware vSAN™ network data storage virtualization component 136 (e.g., a network data storage virtualizer). In the illustrated example, the VRM 124 communicates with these components to manage and present the logical view of underlying resources such as hosts and clusters. The example VRM 124 also uses the logical view for orchestration and provisioning of workloads.

The VMware vSphere® virtualization infrastructure components suite 126 of the illustrated example of FIG. 1 is a collection of components to setup and manage a virtual infrastructure of servers, networks, and other resources. Example components of the VMware vSphere® virtualization infrastructure components suite 126 include the example VMware vCenter® virtual infrastructure server 128 and the example ESXi™ hypervisor component 130.

The example VMware vCenter® virtual infrastructure server 128 provides centralized management of a virtualization infrastructure (e.g., a VMware vSphere® virtualization infrastructure). For example, the VMware vCenter® virtual infrastructure server 128 provides centralized management of virtualized hosts and virtual machines from a single console to provide IT administrators with access to inspect and manage configurations of components of the virtual infrastructure.

The example ESXi™ hypervisor component 130 is a hypervisor that is installed and runs on servers in the example physical hardware resources 112, 114 to enable the servers to be partitioned into multiple logical servers to create virtual machines. The example VMware NSX® network virtualization platform 132 (e.g., a network virtualization component or a network virtualizer) virtualizes network resources such as physical hardware switches to provide software-based virtual networks. The example VMware NSX® network virtualization platform 132 enables physical network resources (e.g., switches) to be treated as a pool of transport capacity. In some examples, the VMware NSX® network virtualization platform 132 also provides network and security services to virtual machines with a policy driven approach.

The example VMware NSX® network virtualization manager 134 manages virtualized network resources such as physical hardware switches to provide software-based virtual networks. In the illustrated example, the VMware NSX® network virtualization manager 134 is a centralized management component of the VMware NSX® network virtualization platform 132 and runs as a virtual appliance on an ESXi host. In the illustrated example of FIG. 1, the VMware NSX® network virtualization manager 134 manages a single vCenter server environment implemented using the VMware vCenter® virtual infrastructure server 128. In the illustrated example of FIG. 1, the VMware NSX® network virtualization manager 134 is in communication with the VMware vCenter® virtual infrastructure server 128, the ESXi™ hypervisor component 130, and the VMware NSX® network virtualization platform 132.

The example VMware vSAN™ network data storage virtualization component 136 is software-defined storage for use in connection with virtualized environments implemented using the VMware vSphere® virtualization infrastructure components suite 126. The example VMware vSAN™ network data storage virtualization component clusters server-attached hard disk drives (HDDs) and solid state drives (SSDs) to create a shared datastore for use as virtual storage resources in virtual environments.

Although the example VMware vSphere® virtualization infrastructure components suite 126, the example VMware vCenter® virtual infrastructure server 128, the example ESXi™ hypervisor component 130, the example VMware NSX® network virtualization platform 132, the example VMware NSX® network virtualization manager 134, and the example VMware vSAN™ network data storage virtualization component 136 are shown in the illustrated example of FIG. 1 as implemented using products developed and sold by VMware, Inc., some or all of such components may alternatively be supplied by components with the same or similar features developed and sold by one or more other virtualization component developers.

The virtualization layer 108 of the illustrated example of FIG. 1, and its associated components are configured to run virtual machines. However, in other examples, the virtualization layer 108 may additionally or alternatively be configured to run containers. A virtual machine refers to a data computer node that operates with its own guest OS on a host using resources of the host virtualized by virtualization software. A container refers to a data computer node that runs on top of a host OS without the need for a hypervisor or separate OS.

The virtual server rack 104 of the illustrated example of FIG. 1 enables abstracting the physical hardware resources 112, 114. In some examples, the virtual server rack 104 includes a set of physical units (e.g., one or more racks) with each unit including hardware resources 112, 114 such as server nodes (e.g., compute+storage+network links), network switches, and, optionally, separate storage units. From a user perspective, the example virtual server rack 104 is an aggregated pool of logic resources exposed as one or more vCenter ESXi™ clusters along with a logical storage pool and network connectivity. In examples disclosed herein, a cluster refers to a server group in a virtual environment. For example, a vCenter ESXi™ cluster refers to a group of physical servers in the physical hardware resources 112, 114 that run ESXi™ hypervisors (developed and sold by VMware, Inc.) to virtualize processor, memory, storage, and networking resources into logical resources to run multiple virtual machines that run OSs and applications as if those OSs and applications were running on physical hardware without an intermediate virtualization layer.

In the illustrated example of FIG. 1, the example OAM layer 110 is an extension of a VMware vCloud® Automation Center (VCAC) that relies on the VCAC functionality and also leverages utilities such as vRealize Automation® (vRA) service 138, Log Insight™, and Hyperic® to deliver a single point of SDDC operations and management. The example OAM layer 110 is configured to provide different services such as heat-map service, capacity planner service, maintenance planner service, events and operational view service, and virtual rack application workloads manager service.

In the illustrated example of FIG. 1, the OAM layer 110 includes an example cloud user interface (UI) 140 that allows data center operators and/or end users to interface with the services of the OAM layer 110. For example, a data center operator may be a cloud administrator such as a tenant, group, fabric, infrastructure, service, IT system, and/or other administrators as defined by business policies and organizational structure. Additionally, for example, an end user may be a cloud (e.g., a tenant) user such as a user in an organization (e.g., an enterprise employee). In the example of FIG. 1, the cloud UI 140 is implemented by a graphical user interface (GUI) implemented by a website hosted by a provider of the virtual server rack 104. In additional or alternative examples, the cloud UI 140 is implemented as a GUI implemented by an application executing on a device (e.g., a mobile phone, a desktop computer, a laptop computer, etc.).

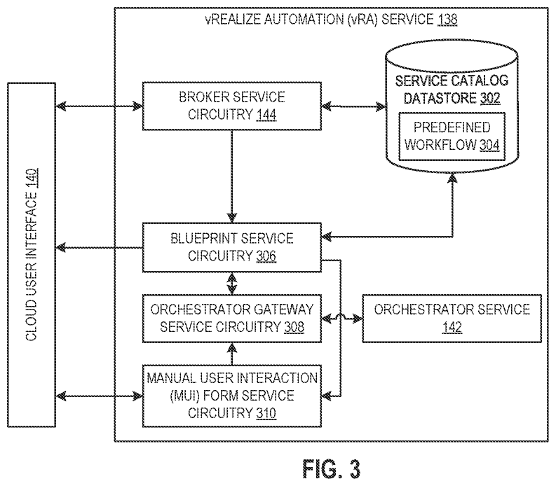

In the illustrated example of FIG. 1, the vRA service 138 is a cloud management platform that can be used to build and manage a multi-vendor cloud infrastructure. The vRA service 138 provides a plurality of services that enable self-provisioning of virtual machines in private and/or public cloud environments, physical machines (install OEM images), applications, and IT services according to policies defined by administrators. For example, the vRA service 138 may include a cloud assembly service to create and deploy machines, applications, and services to a cloud infrastructure, a code stream service to provide a continuous integration and delivery tool for software, example orchestrator service circuitry 142 to automate data center infrastructure tasks, and example broker service circuitry 144 to provide an interface to non-administrative users to develop and build templates for the cloud infrastructure when administrators do not need full access for building and developing. Additional detail of the example vRA service 138 is described further below in connection with FIG. 3. The example vRA service 138 may include a plurality of other services, not described herein, to facilitate building and managing the multi-vendor cloud infrastructure.

In the illustrated example of FIG. 1, a heat map service of the OAM layer 110 exposes component health for hardware mapped to virtualization and application layers (e.g., to indicate good, warning, and critical statuses). The example heat map service also weighs real-time sensor data against offered service level agreements (SLAs) and may trigger some logical operations to make adjustments to ensure continued SLA. In the example of FIG. 1, a capacity planner service of the OAM layer 110 checks against available resources and looks for potential bottlenecks before deployment of an application workload. Example capacity planner services disclosed herein also integrate additional rack units in the collection/stack when capacity is expanded.

In the illustrated example of FIG. 1, a maintenance planner service of the OAM layer 110 dynamically triggers a set of logical operations to relocate virtual machines (VMs) before starting maintenance on a hardware component to increase the likelihood of substantially little or no downtime. The example maintenance planner service of the OAM layer 110 creates a snapshot of the existing state before starting maintenance on an application. The example maintenance planner service of the OAM layer 110 automates software upgrade/maintenance by creating a clone of the machines and proceeding to upgrade software on clones, pause running machines, and attach clones to a network. The example maintenance planner service of the OAM layer 110 also performs rollbacks if upgrades are not successful.

In the illustrated example of FIG. 1, an events and operational views service of the OAM layer 110 provides a single dashboard for logs by feeding to Log Insight™. The example events and operational views service of the OAM layer 110 also correlates events from the heat map service against logs (e.g., a server starts to overheat, connections start to drop, lots of HTTP/503 from App servers). The example events and operational views service of the OAM layer 110 also creates a business operations view (e.g., a top down view from Application Workloads=>Logical Resource View=>Physical Resource View). The example events and operational views service of the OAM layer 110 also provides a logical operations view (e.g., a bottom up view from Physical resource view=>vCenter ESXi Cluster View=>VM's view).

In the illustrated example of FIG. 1, a virtual rack application workloads manager service of the OAM layer 110 uses vCAC and vCAC enterprise services to deploy applications to vSphere hosts. The example virtual rack application workloads manager service of the OAM layer 110 uses data from the heat map service, the capacity planner service, the maintenance planner service, and the events and operational views service to build intelligence to pick the best mix of applications on a host (e.g., not put all high CPU intensive apps on one host). The example virtual rack application workloads manager service of the OAM layer 110 optimizes applications and virtual storage area network (vSAN) arrays to have high data resiliency and best possible performance at same time.

Although the example VCAC, the example vRA service 138, the example Log Insight™, the example Hyperic® are shown in the illustrated example as implemented using products developed and sold by VMware, Inc., some or all of such components may alternatively be supplied by components with the same or similar features developed and sold by one or more other virtualization component developers. For example, the utilities leveraged by the cloud automation center may be any type of cloud computing platform and/or cloud management platform that delivers and/or provides management of the virtual and physical components of the architecture 100.

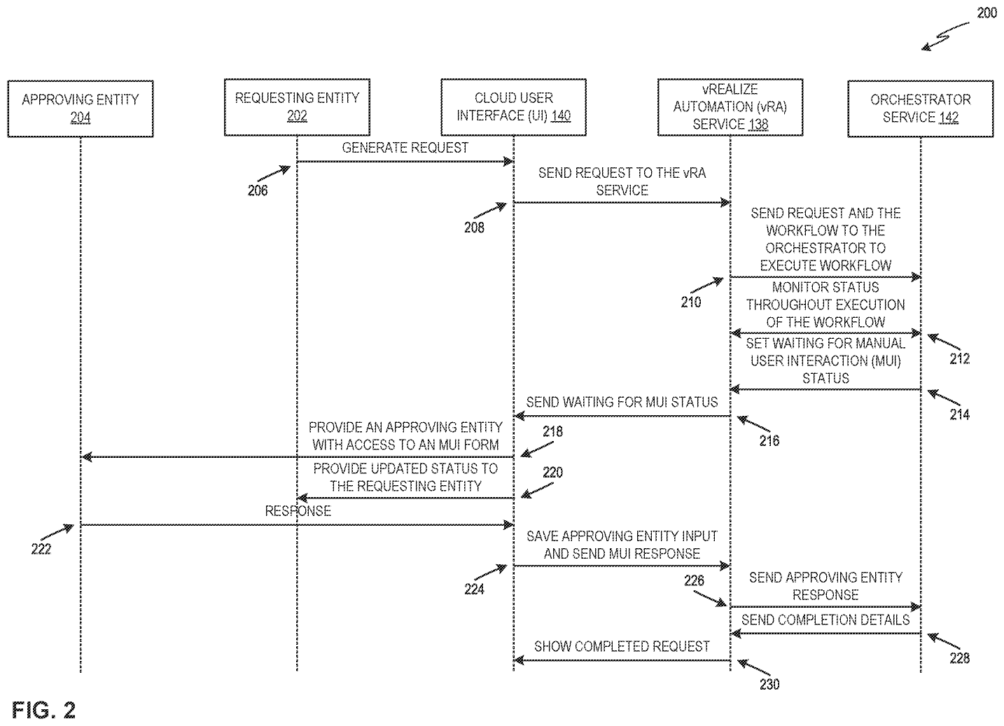

FIG. 2 is a sequence diagram illustrating example operations 200 of the example OAM layer 110 of FIG. 1. The sequence diagram of FIG. 2 includes an example requesting entity 202, an example approving entity 204, the example cloud UI 140, the example vRA service 138, and the example orchestrator service circuitry 142. In the example of FIG. 2, the requesting entity 202 is implemented by a computer (e.g., a smartphone, a tablet, a laptop, a desktop, etc.) operated by an end-user of the virtual server rack 104. For example, the requesting entity 202 is a computer operated by an employee of an enterprise. While in the illustrated example of FIG. 2 the requesting entity 202 is illustrated as a single entity, in some examples, the requesting entity 202 may be implemented by one or more entities.

In the illustrated example of FIG. 2, the approving entity 204 is implemented by one or more computers or devices (e.g., smartphones, tablets, laptops, desktops, etc.) operated by one or more cloud administrators. For example, the approving entity 204 may be included in a group of users authorized to provide input (e.g., approval, denial, approval subject to conditions, etc.) for a decision associated with a request made by the requesting entity 202. Such a group of users may be referred to as a predefined group of approving entities. In such an example, any of the users in the predefined group of approving entities may provide input for the decision. In some examples, at a first time, the approving entity 204 corresponds to one or more first users that have authority to provide input with respect to a first decision in an example workflow, and at a second time, the approving entity 204 corresponds to one or more second users that have authority to provide input with respect to a second decision in the example workflow. In additional or alternative examples, at a first time, the approving entity 204 corresponds to one or more first users that have authority to provide input with respect to a decision in an example workflow, and at a second time, the approving entity 204 corresponds to one or more second users that have authority to confirm or override the decision of the one or more first users.

In the illustrated example of FIG. 2, at an example first operation 206, the requesting entity 202 generates a request. For example, the first operation 206 corresponds to the requesting entity 202 (e.g., an end user logged into their user profile on a desktop computer at an enterprise office) requesting that a new laptop be provisioned (e.g., provisioned for the end user). In the example of FIG. 2, to generate the request, the requesting entity 202 accesses the cloud UI 140 and selects an item included in a catalog hosted by the vRA service 138 (e.g., hosted by the broker service circuitry 144). In examples disclosed herein, a catalog refers to a listing of predefined workflows that a user may request. A predefined workflow refers to a workflow that has been prepared and/or otherwise defined ahead of time before it is requested. For example, such predefined workflows includes workflows for available virtual computing resources (e.g., VMs, load balancers, networking, storage, etc.) that may be provisioned, workflows for available application components (e.g., software services, scripts, code components, application-specific packages, etc.) that may be installed on the provisioned virtual computing resources, workflows to provision physical components to host the virtual computing resources (in the case of a private and/or hybrid cloud), and/or workflows including custom logic defined by an entity associated with an enterprise.

In the illustrated example of FIG. 2, at an example second operation 208, the cloud UI 140 sends the request from the requesting entity 202 to the vRA service 138. For example, at the second operation 208, the cloud UI 140 populates a queue of requests to be handled by the vRA service 138. One or more components of the vRA service 138 (discussed further below in connection with FIG. 3) process the request to identify a cloud service provider associated with the request. For example, the catalog hosted by the vRA service 138 may include workflows associated with more than one cloud service provider (e.g., vRealize Automation® Cloud Assembly cloud templates, Amazon Web Services® CloudFormation templates, etc.). Additionally, at an example third operation 210, the vRA service 138 sends the request and the workflow to the orchestrator service circuitry 142. At the example third operation 210, the vRA service 138 indicates the cloud service provider associated with the requested workflow so that the orchestrator service circuitry 142 can determine the proper cloud service provider with which the workflow is to interact. For example, the orchestrator service circuitry 142 includes one or more APIs corresponding to a cloud service provider. As such, the one or more APIs enable the orchestrator service circuitry 142 to orchestrate workflows being executed by resources of and/or otherwise associated with one or more cloud service providers.

In the illustrated example of FIG. 2, the orchestrator service circuitry 142 executes the requested workflow. For example, if the requesting entity 202 requests provisioning of a laptop, the orchestrator service circuitry 142 may provision and/or otherwise manage computational resources to monitor security of the laptop when executing the workflow. For example, during execution of the workflow, the orchestrator service circuitry 142 establishes a security profile for the laptop, adding the laptop to a list of devices the user who requested the laptop is authorized to access, provisioning an instance of identity as a service (IDaaS) to manage access to the laptop, or the like. While the orchestrator service circuitry 142 executes the workflow, at an example fourth operation 212, the vRA service 138 monitors the status of the workflow. For example, one or more components of the vRA service 138 (discussed further herein) monitor a status field of the orchestrator service circuitry 142. Example workflow statuses include “started,” “in progress,” “waiting,” “completed,” or the like. In the example of FIG. 2, the one or more components of the vRA service 138 periodically monitor the status of the orchestrator service circuitry 142. In some examples, one or more components of the vRA service 138 request (e.g., query, ping, etc.) the orchestrator service circuitry 142 for the status.

In the illustrated example of FIG. 2, at an example fifth operation 214, the orchestrator service circuitry 142 sets a “waiting” status. A status of “waiting” indicates that the workflow requires or awaits a manual user interaction (MUI) to continue execution. Example MUIs correspond to operations in a workflow that require user input. For example, if the requesting entity 202 corresponds to an end user that requested a laptop to be provisioned, one or more MUIs may correspond to approval/denial decisions by one or more entities of an enterprise, depending on a policy established by the enterprise. For example, a first MUI corresponds to a manager of the end user determining whether the enterprise has sufficient capital allocated to an associated project to afford the end user's request. Additionally, in such an example, a second MUI corresponds to an IT system administrator determining whether to approve the end user's request (e.g., based on whether the end user is actually in need of the laptop (or if the end user's request represents a nefarious request), whether the enterprise has a laptop available for the end user, etc.). In such an example, the first MUI and the second MUI may be required by the workflow sequentially (e.g., the workflow requests the first MUI occ and then the second MUI) or concurrently (e.g., the workflow requests the first MUI and the second MUI at the same time).

In some examples, the approving entity 204 accesses an MUI by logging into a profile on a device (e.g., a laptop computer, a smartphone, a tablet, etc.). For example, the approving entity 204 may login to a profile via a website hosted by a provider of the virtual server rack 104. In additional or alternative examples, the approving entity 204 may login to a profile via an application developed by a provider of the virtual server rack 104. As described above, in some examples, the approving entity 204 is included in a group of users authorized to provide input (e.g., approval, denial, approval subject to conditions, etc.) for a decision associated with a request made by the requesting entity 202. In such an example, the approving entity 204 may access a queue of requests and enter input associated with a selected MUI for a request.

In the illustrated example of FIG. 2, at an example sixth operation 216, in response to the status indicating that the workflow requires an MUI to continue execution (e.g., a “waiting” status), the vRA service 138 sends the status to the cloud UI 140. In this manner, the vRA service 138 causes the cloud UI 140 to provide the approving entity 204 with access to an MUI form associated with the MUI required by the workflow at an example seventh operation 218. For example, at the sixth operation 216, the cloud UI 140 updates an approvals tab to reflect that the approving entity 204 has an MUI form queued and available to be reviewed.

Additionally, at an example eighth operation 220, the vRA service 138 causes the cloud UI 140 to provide an updated status to the requesting entity 202. For example, the cloud UI 140 updates a graphical view of the workflow (e.g., illustrating different stages of the workflow) to reflect that the current stage is awaiting approval from the approving entity 204. As such, a user may access the status of the workflow (e.g., by logging into their profile from their personal smartphone to check the status of the requested laptop). At an example ninth operation 222, the approving entity 204 transmits one or more responses to the cloud UI 140.

In the illustrated example of FIG. 2, at an example tenth operation 224, the cloud UI 140 saves the input from the approving entity 204. For example, the cloud UI 140 processes the response from the approving entity 204 and publishes the response in the MUI form. The example vRA service 138 records the responses to the MUI form from the approving entity 204. At an example eleventh operation 226, the vRA service 138 sends the response from the approving entity 204 to the orchestrator service circuitry 142. The example orchestrator service circuitry 142 thereafter continues executing the workflow based on the response from the approving entity 204. If the workflow requires another MUI, the components of FIG. 2 repeat the fifth operation 214, the sixth operation 216, the seventh operation 218, the eighth operation 220, the ninth operation 222, the tenth operation 224, and the eleventh operation 226.

In the illustrated example of FIG. 2, at an example twelfth operation 228, when the orchestrator service circuitry 142 completes execution of the workflow, the orchestrator service circuitry 142 sends completion details of the workflow to the vRA service 138. Additionally, at an example thirteenth operation 230, the vRA service 138 causes the cloud UI 140 to show that the requested workflow has been completed. For example, the cloud UI 140 may update a graphical representation of the workflow to reflect that the workflow is completed (e.g., the requested laptop is available for pickup or has been delivered to the end user's workstation). In additional or alternative examples, the cloud UI 140 may push a notification (e.g., a text, a banner notification, an email, etc.) to the requesting entity 202 indicating that the requested workflow has been completed. In this manner, the end user is made aware that the workflow has been completed and can proceed with other operations in an efficient manner.

FIG. 3 is a block diagram of the vRA service 138 of FIGS. 1 and/or 2 to enable manual user interaction with automated processes. In the illustrated example of FIG. 3, the vRA service 138 includes the example orchestrator service circuitry 142; the example broker service circuitry 144; an example service catalog datastore 302, which includes a predefined workflow 304; an example blueprint service circuitry 306; an example orchestrator gateway service circuitry 308; and an example manual user interaction (MUI) form service circuitry 310. In the example of FIG. 3, the orchestrator service circuitry 142 is in circuit with the orchestrator gateway service circuitry 308. The example broker service circuitry 144 is in circuit with the example cloud UI 140, the example service catalog datastore 302, and the example blueprint service circuitry 306. In the example of FIG. 3, the blueprint service circuitry 306 is in circuit with the cloud UI 140, the broker service circuitry 144, the service catalog datastore 302, the orchestrator gateway service circuitry 308, and the MUI form service circuitry 310. The example orchestrator gateway service circuitry 308 is in circuit with the example orchestrator service circuitry 142, the example blueprint service circuitry 306, and the example MUI form service circuitry 310. In the example of FIG. 3, the MUI form service circuitry 310 is in circuit with the cloud UI 140, the blueprint service circuitry 306, and the orchestrator gateway service circuitry 308.

In the illustrated example of FIG. 3, the vRA service 138 is installed as executable instructions (e.g., VMs, containers, etc.) at one or more server hosts of one or more physical racks forming the virtual server rack 104. As such, any of the orchestrator service circuitry 142, the broker service circuitry 144, the blueprint service circuitry 306, the orchestrator gateway service circuitry 308, and/or the MUI form service circuitry 310 may be implemented as executable instructions installed at one or more physical racks forming the virtual server rack 104. Thus, in some examples, the orchestrator service circuitry 142 is implemented by orchestrator service instructions. Additionally, in some examples, the broker service circuitry 144 is implemented by broker service instructions. Also, in some examples, the blueprint service circuitry 306 is implemented by blueprint service instructions. In some examples, the orchestrator gateway service circuitry 308 is implemented by orchestrator gateway service instructions. Additionally, in some examples, the MUI form service circuitry 310 is implemented by MUI form service instructions.

Additionally, in the example of FIG. 3, the example vRA service 138 may be instantiated (e.g., creating an instance of, bring into being for any length of time, materialize, implement, etc.) by processor circuitry such as a central processing unit executing instructions as described above. Additionally or alternatively, the vRA service 138 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by one or more virtual machines and/or containers executing on the microprocessor.

Thus, in some examples, the orchestrator service circuitry 142 is implemented by orchestrator service circuitry. Additionally, in some examples, the broker service circuitry 144 is implemented by broker service circuitry. Also, in some examples, the blueprint service circuitry 306 is implemented by blueprint service circuitry. In some examples, the orchestrator gateway service circuitry 308 is implemented by orchestrator gateway service circuitry. Additionally, in some examples, the MUI form service circuitry 310 is implemented by MUI form service circuitry.

In the illustrated example of FIG. 3, the service catalog datastore 302 is prepopulated and/or customized by an administrator (e.g., IT system administrator) that enters in specifications, configurations, properties, and/or other details about items in a catalog hosted by the vRA service 138 (e.g., the broker service circuitry 144). In some examples, an administrator can develop a custom blueprint that is assembled from items (e.g., templates) stored in the service catalog datastore 302, which includes a listing of available virtual computing resources (e.g., VMs, networking, storage, etc.) that may be provisioned from one or more cloud service providers and available application components (e.g., software services, scripts, code components, application-specific packages) that may be installed on the provisioned virtual computing resources.

In the illustrated example of FIG. 3, catalog items are defined by one or more blueprints. An example blueprint specifies a logical topology of an application to be deployed. Example blueprints generally capture the structure of an application as a collection of application components executing on virtual computing resources. For example, an example blueprint for an online store application may specify a web application (e.g., in the form of a Java web application archive (WAR) file including dynamic web pages, static web pages, Java servlets, Java classes, and/or other property, configuration and/or resources files that make up a Java web application) executing on an application server (e.g., Apache Tomcat application server) that uses a database (e.g., MongoDB) as a datastore.

As used herein, the term “application” generally refers to a logical deployment unit, including of one or more application packages and their dependent middleware and/or operating systems. Applications may be distributed across multiple VMs. Thus, in the example described above, the term “application” refers to the entire online store application, including application server and database components, rather than just the web application itself In some instances, the application may include the underlying hardware and/or virtual computing hardware utilized to implement the components. Based on the application, example blueprints may define one or more dependencies between application components to indicate an installation order of the application components during deployment. For example, since a load balancer usually cannot be configured until a web application is up and running, an administrator developing an application may specify a dependency from an Apache service to an application code package.

In the illustrated example of FIG. 3, the service catalog datastore 302 includes the predefined workflow 304. As described above, in some examples, the predefined workflow 304 is customized by an administrator. For example, a custom catalog item may reflect custom logic defined by an administrator to achieve a particular task dependent on a particular use-case of an enterprise with which the administrator is associated. After a custom catalog item is defined, the administrator can publish the catalog item in the service catalog datastore 302, making it available to end users via the broker service circuitry 144.

In the illustrated example of FIG. 3, the service catalog datastore 302 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The service catalog datastore 302 may additionally or alternatively be implemented by one or more double data rate (DDR) memories, such as DDR, DDR2, DDR3, DDR4, DDR5, mobile DDR (mDDR), DDR SDRAM, etc. The service catalog datastore 302 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the service catalog datastore 302 is illustrated as a single database, the service catalog datastore 302 may be implemented by any number and/or type(s) of databases. Furthermore, the data stored in the service catalog datastore 302 may be in any data format such as, for example, binary data, comma delimited data, tab delimited data, structured query language (SQL) structures, etc.

In the illustrated example of FIG. 3, the orchestrator service circuitry 142 is an embedded or internal orchestrator of the vRA service 138. The example orchestrator service circuitry 142 processes workflows, which can leverage a provisioning manager, such as the service catalog datastore 302, to provision VM services. For example, the orchestrator service circuitry 142 can be used to invoke a blueprint to provision a manager for services. Example services include catalog services, identity services, component registry services, event broker services, IaaS, anything as a service (XaaS), etc. Example catalog services provide a user interface via which a user can request provisioning of different preset environments (e.g., a VM including an operating system and software and some customization, etc.), similar to the service catalog datastore 302. Identity services facilitate authentication and authorization of users and assigned roles, for example. Example component registry services maintain information corresponding to installed and deployed services (e.g., uniform resource locators for services installed in a VM and/or virtual appliance, etc.). Event broker services provide a messaging broker for event-based communication, for example. Example IaaS provisions one or more VMs and/or containers for a customer via the vRA service 138. XaaS extends this to also request, approve, provision, operate, and decommission any type of catalog item (e.g., storage, applications, accounts, and anything else that the catalog provides as a service), for example.

In the illustrated example of FIG. 3, the broker service circuitry 144 hosts a catalog that is accessible to end users and/or administrators. For example, the broker service circuitry 144 hosts one or more APIs enabling the cloud UI 140 to communicate with the service catalog datastore 302. As such, the broker service circuitry 144 allows administrators (accessing the cloud UI 140) to populate the service catalog datastore 302 with catalog items. Additionally, the broker service circuitry 144 allows end users (accessing the cloud UI 140) to request such catalog items.

Thus, for example, at a first time, an administrator may define the predefined workflow 304 (e.g., a workflow to provision a load balancer) and upload the predefined workflow 304 to the broker service circuitry 144. In response to receipt of the predefined workflow 304, the broker service circuitry 144 imports (e.g., stores) the predefined workflow 304 in the service catalog datastore 302. At a second time (e.g., later than the first time), an end user requests the predefined workflow 304 (e.g., provision a load balancer) from the broker service circuitry 144. In response to receipt of the request for the predefined workflow 304, the broker service circuitry 144 forwards the request to the blueprint service circuitry 306.

In the illustrated example of FIG. 3, the blueprint service circuitry 306 communicates with different cloud service providers accessible to the orchestrator service circuitry 142. As described above, in some examples the service catalog datastore 302 includes workflows associated with more than one cloud service provider and the orchestrator service circuitry 142 includes one or more APIs corresponding to one or more cloud service providers. As such, the blueprint service circuitry 306 is configured to review requests for catalog items to identify a cloud service provider associated with the requested workflow. In response to identifying the cloud service provider associated with the request, the blueprint service circuitry 306 forwards the request and the workflow to the orchestrator gateway service circuitry 308 and indicates an API of the orchestrator service circuitry 142 with which the orchestrator gateway service circuitry 308 is to communicate.

In the illustrated example of FIG. 3, as the orchestrator service circuitry 142 executes the requested workflow, the blueprint service circuitry 306 monitors (e.g., periodically or aperiodically) the status of the workflow. For example, as the orchestrator service circuitry 142 executes the workflow, the orchestrator service circuitry 142 populates a field with the current status of the workflow. To monitor this field, the blueprint service circuitry 306 requests that the orchestrator gateway service circuitry 308 provide the current status of the workflow. Based on the status, the blueprint service circuitry 306 operates differently. For example, if the orchestrator gateway service circuitry 308 provides a status of “in progress,” the blueprint service circuitry 306 waits for some time (e.g., a predefined period) before again requesting the status from the orchestrator gateway service circuitry 308.

As described above, a status of “waiting” indicates that the workflow requires a manual user interaction (MUI) to continue execution. Thus, in the example of FIG. 3, if the orchestrator gateway service circuitry 308 provides a status of “waiting,” the blueprint service circuitry 306 communicates to the cloud UI 140 that the requested workflow is awaiting approval. As such, the blueprint service circuitry 306 causes the cloud UI 140 to provide an updated status to the requesting entity that requested the workflow. Additionally, if the orchestrator gateway service circuitry 308 provides a status of “waiting,” the blueprint service circuitry 306 requests that the MUI form service circuitry 310 transmit an MUI custom form associated with the MUI required by the workflow to an authorized approver (e.g., the approving entity 204).

In the illustrated example of FIG. 3, the orchestrator gateway service circuitry 308 is in communication with the blueprint service circuitry 306 and the MUI form service circuitry 310 to facilitate communication with the orchestrator service circuitry 142. For example, in response to receiving a request and a workflow from the blueprint service circuitry 306, the orchestrator gateway service circuitry 308 forwards the request and the workflow to an API of the orchestrator service circuitry 142 that is indicated by the blueprint service circuitry 306. Additionally, in response to a request from the blueprint service circuitry 306 for a status of the workflow, the orchestrator gateway service circuitry 308 provides the current status of the workflow to the blueprint service circuitry 306. In some examples, the orchestrator gateway service circuitry 308 pushes workflow status to the blueprint service circuitry 306 as the workflow status becomes available and/or as the workflow status changes. Additionally, in response to receiving one or more responses to an MUI form from the MUI form service circuitry 310, the orchestrator gateway service circuitry 308 sends the one or more responses to the orchestrator service circuitry 142 to enable the orchestrator service to continue execution of the workflow.

In the illustrated example of FIG. 3, the MUI form service circuitry 310 manages MUIs for the vRA service 138. For example, in response to a request from the blueprint service circuitry 306 for an MUI custom form (e.g., in response to the status indicating that the workflow requires an MUI to continue execution), the MUI form service circuitry 310 forwards the MUI form for the required MUI to the cloud UI 140. In this manner, the MUI form service circuitry 310 causes the cloud UI 140 to provide an approving entity with access to an MUI form associated with the MUI. In response to the approving entity responding to the MUI, the cloud UI 140 populates the MUI form with the one or more responses from the approving entity. The MUI form service circuitry 310 records the one or more responses to the MUI form from the approving entity and forwards the responses to the orchestrator gateway service circuitry 308.

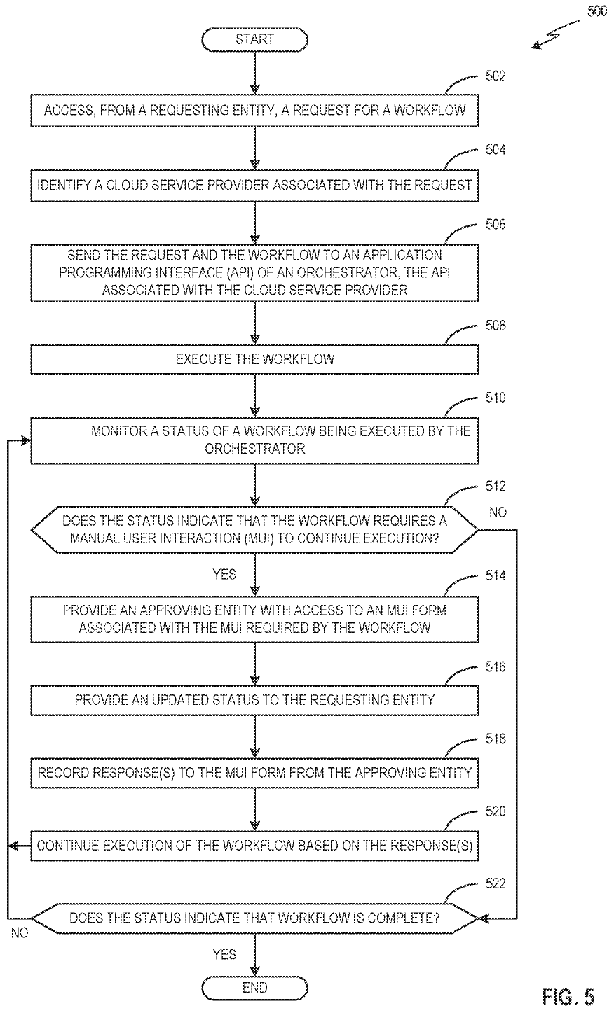

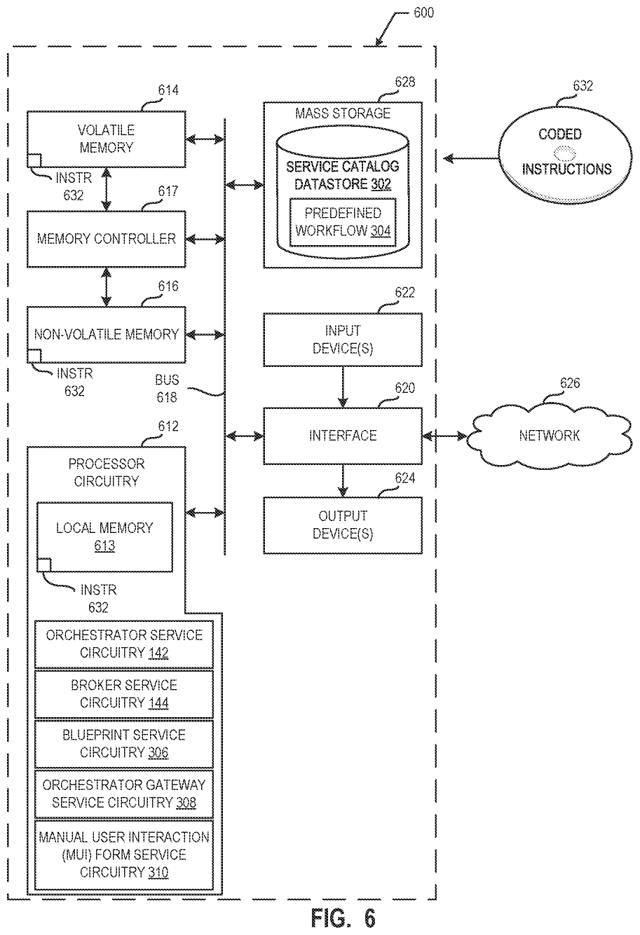

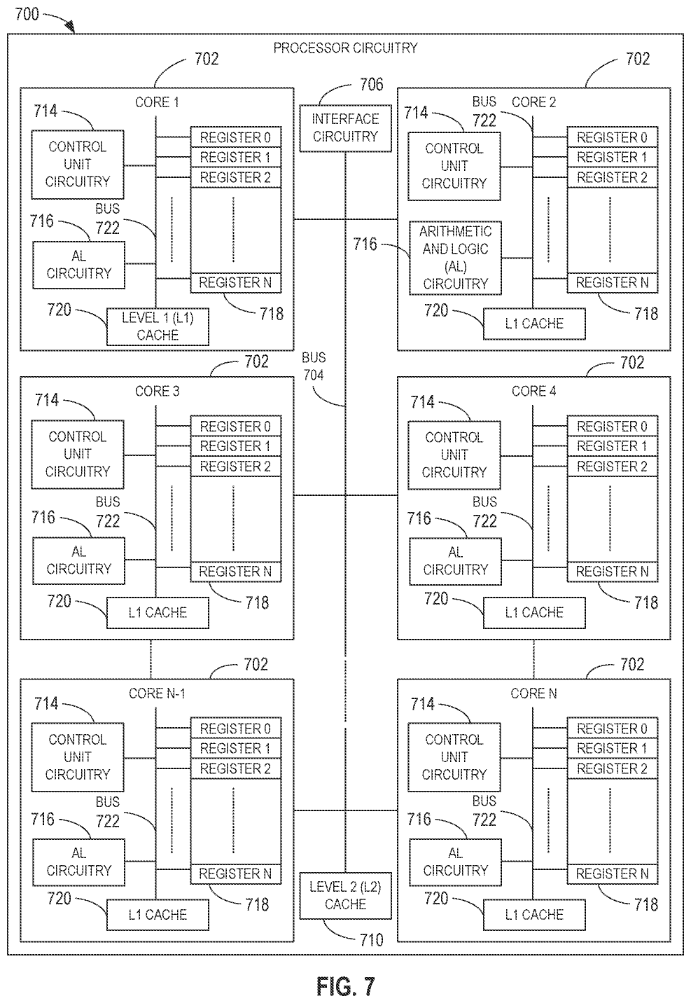

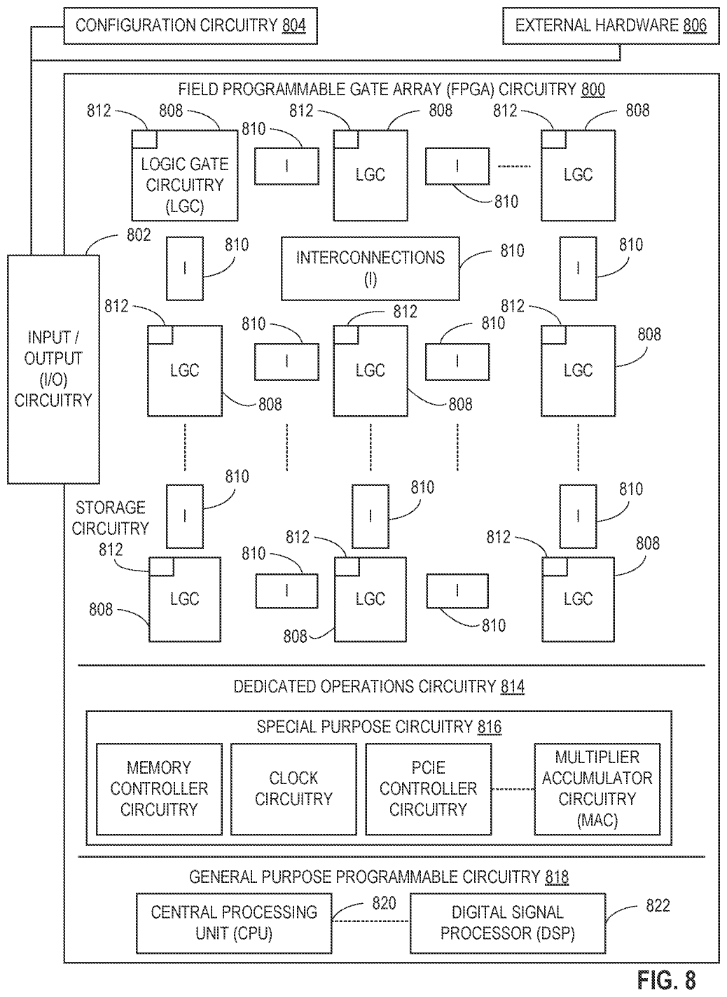

In some examples, the vRA service 138 includes means for orchestrating workflows. For example, the means for orchestrating workflows may be implemented by the orchestrator service circuitry 142. In some examples, the orchestrator service circuitry 142 may be instantiated by processor circuitry such as the example processor circuitry 612 of FIG. 6. For instance, the orchestrator service circuitry 142 may be instantiated by the example general purpose microprocessor circuitry 700 of FIG. 7 executing machine executable instructions such as that implemented by at least blocks 508 and 520 of FIG. 5. In some examples, the orchestrator service circuitry 142 may be instantiated by hardware logic circuitry, which may be implemented by an ASIC or the FPGA circuitry 800 of FIG. 8 structured to perform operations corresponding to the machine readable instructions. Additionally or alternatively, the orchestrator service circuitry 142 may be instantiated by any other combination of hardware, software, and/or firmware. For example, the orchestrator service circuitry 142 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the vRA service 138 includes means for brokering catalog items. For example, the means for brokering catalog items may be implemented by the broker service circuitry 144. In some examples, the broker service circuitry 144 may be instantiated by processor circuitry such as the example processor circuitry 612 of FIG. 6. For instance, the broker service circuitry 144 may be instantiated by the example general purpose microprocessor circuitry 700 of FIG. 7 executing machine executable instructions such as that implemented by at least block 502 of FIG. 5. In some examples, the broker service circuitry 144 may be instantiated by hardware logic circuitry, which may be implemented by an ASIC or the FPGA circuitry 800 of FIG. 8 structured to perform operations corresponding to the machine readable instructions. Additionally or alternatively, the broker service circuitry 144 may be instantiated by any other combination of hardware, software, and/or firmware. For example, the broker service circuitry 144 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

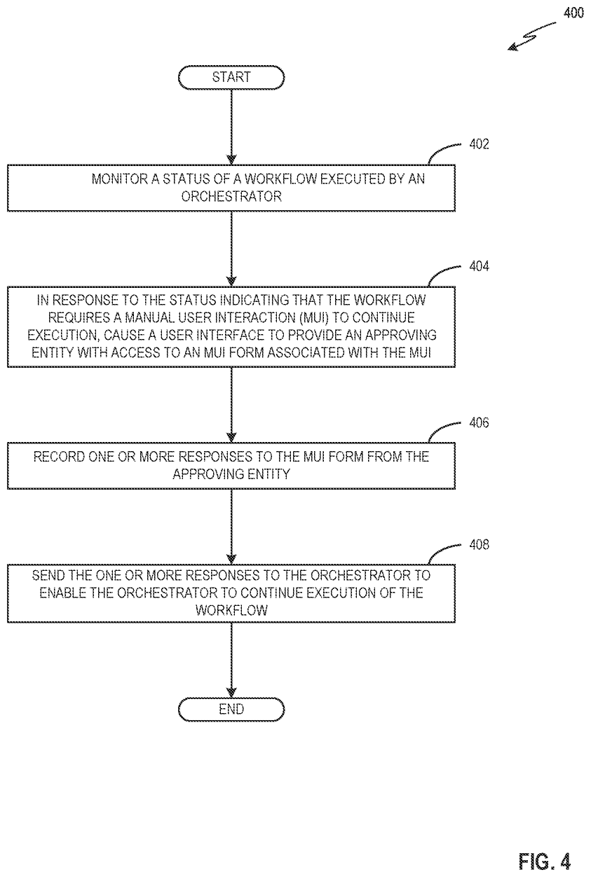

In some examples, the vRA service 138 includes means for managing workflows. For example, the means for managing workflows may be implemented by the blueprint service circuitry 306. In some examples, the blueprint service circuitry 306 may be instantiated by processor circuitry such as the example processor circuitry 612 of FIG. 6. For instance, the blueprint service circuitry 306 may be instantiated by the example general purpose microprocessor circuitry 700 of FIG. 7 executing machine executable instructions such as that implemented by at least block 402 of FIG. 4 and/or at least blocks 504, 510, 512, 516, and 522 of FIG. 5. In some examples, the blueprint service circuitry 306 may be instantiated by hardware logic circuitry, which may be implemented by an ASIC or the FPGA circuitry 800 of FIG. 8 structured to perform operations corresponding to the machine readable instructions. Additionally or alternatively, the blueprint service circuitry 306 may be instantiated by any other combination of hardware, software, and/or firmware. For example, the blueprint service circuitry 306 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the vRA service 138 includes means for communicating with an orchestrator. For example, the means for communicating with an orchestrator may be implemented by the orchestrator gateway service circuitry 308. In some examples, the orchestrator gateway service circuitry 308 may be instantiated by processor circuitry such as the example processor circuitry 612 of FIG. 6. For instance, the orchestrator gateway service circuitry 308 may be instantiated by the example general purpose microprocessor circuitry 700 of FIG. 7 executing machine executable instructions such as that implemented by at least block 408 of FIG. 4 and/or at least block 508 of FIG. 5. In some examples, the orchestrator gateway service circuitry 308 may be instantiated by hardware logic circuitry, which may be implemented by an ASIC or the FPGA circuitry 800 of FIG. 8 structured to perform operations corresponding to the machine readable instructions. Additionally or alternatively, the orchestrator gateway service circuitry 308 may be instantiated by any other combination of hardware, software, and/or firmware. For example, the orchestrator gateway service circuitry 308 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the vRA service 138 includes means for managing manual user interactions (MUIs). For example, the means for managing MUIs may be implemented by the MUI form service circuitry 310. In some examples, the MUI form service circuitry 310 may be instantiated by processor circuitry such as the example processor circuitry 612 of FIG. 6. For instance, the MUI form service circuitry 310 may be instantiated by the example general purpose microprocessor circuitry 700 of FIG. 7 executing machine executable instructions such as that implemented by at least blocks 404 and 406 of FIG. 4 and/or at least blocks 514 and 518 of FIG. 5. In some examples, the MUI form service circuitry 310 may be instantiated by hardware logic circuitry, which may be implemented by an ASIC or the FPGA circuitry 800 of FIG. 8 structured to perform operations corresponding to the machine readable instructions. Additionally or alternatively, the MUI form service circuitry 310 may be instantiated by any other combination of hardware, software, and/or firmware. For example, the MUI form service circuitry 310 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the vRA service 138 of FIGS. 1 and/or 2 is illustrated in FIG. 3, one or more of the elements, processes, and/or devices illustrated in FIG. 3 may be combined, divided, re-arranged, omitted, eliminated, and/or implemented in any other way. Further, the example orchestrator service circuitry 142, the example broker service circuitry 144, the example service catalog datastore 302, the example blueprint service circuitry 306, the example orchestrator gateway service circuitry 308, the example MUI form service circuitry 310, and/or, more generally, the example vRA service 138 of FIGS. 1, 2, and/or 3, may be implemented by hardware alone or by hardware in combination with software and/or firmware. Thus, for example, any of the example orchestrator service circuitry 142, the example broker service circuitry 144, the example service catalog datastore 302, the example blueprint service circuitry 306, the example orchestrator gateway service circuitry 308, the example MUI form service circuitry 310, and/or, more generally, the example vRA service 138 of FIGS. 1, 2, and/or 3, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example vRA service 138 of FIGS. 1 and/or 2 may include one or more elements, processes, and/or devices in addition to, or instead of, those illustrated in FIG. 3, and/or may include more than one of any or all of the illustrated elements, processes, and devices.

Flowchart representative of example hardware logic circuitry, machine readable instructions, hardware implemented state machines, and/or any combination thereof for implementing the vRA service 138 of FIGS. 1, 2, and/or 3 are shown in FIGS. 4 and 5. The machine readable instructions may be one or more executable programs or portion(s) of an executable program for execution by processor circuitry, such as the processor circuitry612 shown in the example processor platform 600 discussed below in connection with FIG. 6 and/or the example processor circuitry discussed below in connection with FIGS. 7 and/or 8. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 4 and 5, many other methods of implementing the example vRA service 138 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and/or 5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed and/or instantiated by processor circuitry to implement the vRA service 138 of FIGS. 1, 2, and/or 3 to enable MUI with automated processes. The machine readable instructions and/or the operations 400 of FIG. 4 begin at block 402, at which the example blueprint service circuitry 306 (FIG. 3) monitors a status of a requested workflow, the workflow executed by the orchestrator service circuitry 142 (FIGS. 1-3). At block 404, the example MUI form service circuitry 310, in response to the status indicating that the workflow requires or awaits an MUI to continue execution, causes the cloud UI 140 (FIGS. 1-3) (e.g., a user interface) to provide an approving entity (e.g., the approving entity 204 of FIG. 2) with access to an MUI form associated with the MUI.

In the illustrated example of FIG. 4, at block 406, the example MUI form service circuitry 310 (FIG. 3) records one or more responses to the MUI form from the approving entity. At block 408, the example orchestrator gateway service circuitry 308 (FIG. 3) sends the one or more responses to the orchestrator service circuitry 142 to enable the orchestrator service circuitry 142 to continue execution of the workflow. Thereafter, the machine readable instructions and/or the operations 400 terminate.

FIG. 5 is a flowchart representative of additional example machine readable instructions and/or example operations 500 that may be executed and/or instantiated by processor circuitry to implement the vRA service 138 of FIGS. 1, 2, and/or 3 to enable MUI with automated processes. The machine readable instructions and/or the operations 500 of FIG. 5 begin at block 502, at which the example broker service circuitry 144 (FIGS. 1 and 3) accesses, from a requesting entity (e.g., the requesting entity 202 of FIG. 2), a request for a workflow. For example, the broker service circuitry 144 accesses a request for a workflow via the cloud UI 140 (FIGS. 1-3). The example broker service circuitry 144 thereafter forwards the request to the blueprint service circuitry 306 (FIG. 3). At block 504, the example blueprint service circuitry 306 identifies a cloud service provider associated with the request. In response to identifying the cloud service provider, the example blueprint service circuitry 306 forwards the request and the workflow to the orchestrator gateway service circuitry 308 (FIG. 3). The example blueprint service circuitry 306 also indicates the API of the orchestrator service circuitry 142 (FIGS. 1-3) associated with the cloud service provider.

In the illustrated example of FIG. 5, at block 506, the orchestrator gateway service circuitry 308 sends the request and the workflow to the API or the orchestrator service circuitry 142. At block 508, the example orchestrator service circuitry 142 executes the workflow. At block 510, the example blueprint service circuitry 306 monitors a status of the workflow being executed by the orchestrator service circuitry 142. For example, the blueprint service circuitry 306 requests that the orchestrator gateway service circuitry 308 provide the status of the workflow. At block 512, the example blueprint service circuitry 306 determines whether the status of the workflow indicates that the workflow requires an MUI to continue execution. For example, the blueprint service circuitry 306 accesses the status of the workflow to determine whether the workflow requires an MUI. An example status indicative of a workflow requiring an MUI is a “waiting” status. However, any other suitable status may additionally or alternatively be used to indicate that a workflow is awaiting an MUI.

In the illustrated example of FIG. 5, in response to the blueprint service circuitry 306 determining that the status of the workflow indicates that the workflow does not require an MUI to continue execution (block 512: NO), the machine readable instructions and/or the operations 500 proceed to block 522. In response to the example blueprint service circuitry 306 determining that the status of the workflow indicates that the workflow requires an MUI to continue execution (block 512: YES), the machine readable instructions and/or the operations 500 proceed to block 514. At block 514, the example MUI form service circuitry 310 (FIG. 3) provides an approving entity (e.g., the approving entity 204 of FIG. 2) with access to an MUI form associated with the MUI required by the workflow. For example, the MUI form service circuitry 310 causes the cloud UI 140 to provide access to the MUI form. At block 516, the example blueprint service circuitry 306 provides an updated status to the requesting entity (e.g., the requesting entity 202). For example, the blueprint service circuitry 306 causes the cloud UI 140 to update the status of the workflow.

In the illustrated example of FIG. 5, at block 518, the MUI form service circuitry 310 records one or more responses to the MUI form from the approving entity (e.g., the approving entity 204). The example MUI form service circuitry 310 sends the one or more responses to the orchestrator gateway service circuitry 308. In response to receipt of the one or more responses, the example orchestrator gateway service circuitry 308 sends the one or more responses to the orchestrator service circuitry 142. At block 520, the example orchestrator service circuitry 142 continues to execute the workflow based on the responses. Thereafter, the machine readable instructions and/or the operations 500 return to block 510.

In the illustrated example of FIG. 5, at block 522, the blueprint service circuitry 306 determines whether the status of the workflow indicates that the workflow is complete. In response to the example blueprint service circuitry 306 determining that the status of the workflow indicates that the workflow is not complete (block 522: NO), the machine readable instructions and/or the operations 500 return to block 510. In response to the example blueprint service circuitry 306 determining that the status of the workflow indicates that the workflow is complete (block 522: YES), the machine readable instructions and/or the operations 500 terminate.

FIG. 6 is a block diagram of an example processor platform 600 structured to execute and/or instantiate the machine readable instructions and/or the operations 400 of FIG. 4 and/or the machine readable instructions and/or the operations 500 of FIG. 5 to implement the vRA service 138 of FIGS. 1, 2, and/or 3. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs, microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the example orchestrator service circuitry 142, the example broker service circuitry 144, the example blueprint service circuitry 306, the example orchestrator gateway service circuitry 308, and the example MUI form service circuitry 310.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 628 implement the example service catalog datastore 302 which stores the example predefined workflow 304.

The machine executable instructions 632, which may be implemented by the machine readable instructions and/or the operations 400 of FIG. 4 and/or the machine readable instructions and/or the operations 500 of FIG. 5, may be stored in the mass storage device 628, in the volatile memory 414, in the non-volatile memory 616, and/or on a removable non-transitory computer readable storage medium such as a CD or DVD.

FIG. 7 is a block diagram of an example implementation of the processor circuitry 612 of FIG. 6. In this example, the processor circuitry 612 of FIG. 6 is implemented by a general purpose microprocessor circuitry 700. The general purpose microprocessor circuitry 700 executes some or all of the machine readable instructions of the flowcharts of FIGS. 4 and/or 5 to effectively instantiate the circuitry of FIG. 3 as logic circuits to perform the operations corresponding to those machine readable instructions. In some such examples, the circuitry of FIG. 3 is instantiated by the hardware circuits of the microprocessor circuitry 700 in combination with the instructions. For example, the microprocessor circuitry 700 may implement multi-core hardware circuitry such as a CPU, a DSP, a GPU, an XPU, etc. Although it may include any number of example cores 702 (e.g., 1 core), the microprocessor circuitry 700 of this example is a multi-core semiconductor device including N cores. The cores 702 of the microprocessor circuitry 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4 and/or 5.

The cores 702 may communicate by a first example bus 704. In some examples, the first bus 704 may implement a communication bus to effectuate communication associated with one(s) of the cores 702. For example, the first bus 704 may implement at least one of an Inter-Integrated Circuit (I2C) bus, a Serial Peripheral Interface (SPI) bus, a PCI bus, or a PCIe bus. Additionally or alternatively, the first bus 704 may implement any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor circuitry 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry 716 (e.g., arithmetic and logic circuitry), a plurality of registers 718, the L1 cache 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 (e.g., control circuitry) includes semiconductor-based circuits structured to control data movement (e.g., coordinate data movement) within the corresponding core 702. The AL circuitry 716 includes semiconductor-based circuits structured to perform one or more mathematic and/or logic operations on the data within the corresponding core 702, the one or more operations corresponding to instructions. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The second bus 722 may implement at least one of an I2C bus, a SPI bus, a PCI bus, or a PCIe bus

Each core 702 and/or, more generally, the microprocessor circuitry 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor circuitry 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 8 is a block diagram of another example implementation of the processor circuitry 612 of FIG. 6. In this example, the processor circuitry 612 is implemented by FPGA circuitry 800. The FPGA circuitry 800 can be used, for example, to perform operations that could otherwise be performed by the example microprocessor circuitry 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor circuitry 700 of FIG. 7 described above (which is a general purpose device that may be programmed to execute some or all of the machine readable instructions represented by the flowcharts of FIGS. 4 and/or 5 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowcharts of FIGS. 4 and/or 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowcharts of FIGS. 4 and/or 5. As such, the FPGA circuitry 800 may be structured to effectively instantiate some or all of the machine readable instructions of the flowcharts of FIGS. 4 and/or 5 as dedicated logic circuits to perform the operations corresponding to those software instructions in a dedicated manner analogous to an ASIC. Therefore, the FPGA circuitry 800 may perform the operations corresponding to the some or all of the machine readable instructions of FIGS. 4 and/or 5 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware (e.g., external hardware circuitry) 806. For example, the configuration circuitry 804 may implement interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may implement the microprocessor circuitry 700 of FIG. 7. The FPGA circuitry 800 also includes an array of example logic gate circuitry 808, a plurality of example configurable interconnections 810, and example storage circuitry 812. The logic gate circuitry 808 and interconnections 810 are configurable to instantiate one or more operations that may correspond to at least some of the machine readable instructions of FIGS. 4 and/or 5 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor circuitry 700 of FIG. 7 and the example FPGA circuitry 800 of FIG. 8. In some such hybrid examples, a first portion of the machine readable instructions represented by the flowcharts of FIGS. 4 and/or 5 may be executed by one or more of the cores 702 of FIG. 7, a second portion of the machine readable instructions represented by the flowcharts of FIGS. 4 and/or 5 may be executed by the FPGA circuitry 800 of FIG. 8, and/or a third portion of the machine readable instructions represented by the flowcharts of FIGS. 4 and/or 5 may be executed by an ASIC. It should be understood that some or all of the circuitry of FIG. 3 may, thus, be instantiated at the same or different times. Some or all of the circuitry may be instantiated, for example, in one or more threads executing concurrently and/or in series. Moreover, in some examples, some or all of the circuitry of FIG. 3 may be implemented within one or more virtual machines and/or containers executing on the microprocessor.

In some examples, the processor circuitry 612 of FIG. 6 may be in one or more packages. For example, the microprocessor circuitry 700 of FIG. 7 and/or the FPGA circuitry 800 of FIG. 8 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

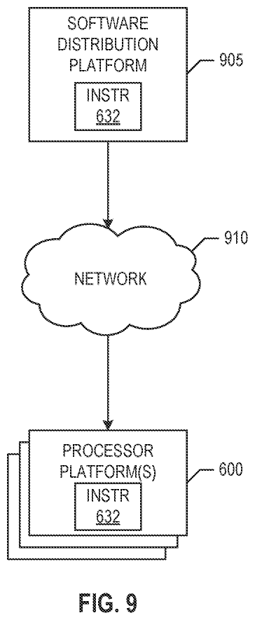

A block diagram illustrating an example software distribution platform 905 to distribute software such as the example machine readable instructions 632 of FIG. 6 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions and/or the example operations 400 of FIG. 4 and/or the example machine readable instructions and/or the example operations 500 of FIG. 5, as described above. The one or more servers of the example software distribution platform 905 are in communication with a network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions and/or the example operations 400 of FIG. 4 and/or the example machine readable instructions and/or the example operations 500 of FIG. 5, may be downloaded to the example processor platform 600, which is to execute the machine readable instructions 632 to implement the vRA service 138 of FIGS. 1, 2, and/or 3. In some example, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices.

From the foregoing, it will be appreciated that example systems, methods, apparatus, and articles of manufacture have been disclosed that enable manual user interaction with automated processes. Example systems, methods, apparatus, and articles of manufacture disclosed herein allow users to exercise control over automated processes. As such, users can ensure that an overall deployment is not overburdened. For example, without examples disclosed herein, a request to provision a VM would be automatically implemented without approval from an administrator and could potentially overburden computational resources hosting the deployment, thereby degrading the ability of the computational resources to handle processing of workflows. Disclosed systems, methods, apparatus, and articles of manufacture improve the efficiency of using a computing device by improving control of automated processes in a manner that prevents overburdening of computational resources. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to enable manual user interaction with automated processes are disclosed herein. Further examples and combinations thereof include the following:

Example 1 includes an apparatus to enable manual user interaction (MUI) with automated processes, the apparatus comprising a service catalog datastore including a workflow, and processor circuitry including one or more of at least one of a central processor unit (CPU), a graphics processor unit (GPU), or a digital signal processor (DSP), the at least one of the CPU, the GPU, or the DSP having control circuitry to control data movement within the processor circuitry, arithmetic and logic circuitry to perform one or more first operations corresponding to instructions, and one or more registers to store a first result of the one or more first operations, the instructions in the apparatus, a Field Programmable Gate Array (FPGA), the FPGA including first logic gate circuitry, a plurality of configurable interconnections, and storage circuitry, the first logic gate circuitry and interconnections to perform one or more second operations, the storage circuitry to store a second result of the one or more second operations, or Application Specific Integrated Circuitry (ASIC) including second logic gate circuitry to perform one or more third operations, the processor circuitry to perform at least one of the first operations, the second operations, or the third operations to instantiate blueprint service circuitry to monitor a status of the workflow, the workflow executed by an orchestrator, MUI form service circuitry to in response to the status indicating that the workflow requires an MUI to continue execution, cause a user interface to provide an approving entity with access to an MUI form associated with the MUI, and record one or more responses to the MUI form from the approving entity, and orchestrator gateway service circuitry to send the one or more responses to the orchestrator to enable the orchestrator to continue execution of the workflow.

Example 2 includes the apparatus of example 1, wherein the processor circuitry is to perform at least one of the first operations, the second operations, or the third operations to instantiate broker service circuitry to access, from a requesting entity, a request for the workflow, wherein the blueprint service circuitry is to identify a cloud service provider associated with the request, and the orchestrator gateway service circuitry is to send the request and the workflow to an application programming interface (API) of the orchestrator, the API associated with the cloud service provider.

Example 3 includes the apparatus of example 1, wherein the processor circuitry is to perform at least one of the first operations, the second operations, or the third operations to instantiate the blueprint service circuitry to, in response to the status indicating that the workflow requires the MUI to continue execution, cause the user interface to provide an updated status to a requesting entity that requested the workflow.

Example 4 includes the apparatus of example 1, wherein the approving entity is included in a predefined group of approving entities, and the processor circuitry is to perform at least one of the first operations, the second operations, or the third operations to instantiate the MUI form service circuitry to, in response to the status indicating that the workflow requires the MUI to continue execution, cause the user interface to provide the predefined group of approving entities with access to the MUI form associated with the MUI.

Example 5 includes the apparatus of example 1, wherein the processor circuitry is to perform at least one of the first operations, the second operations, or the third operations to instantiate the blueprint service circuitry to request the status of the workflow periodically.

Example 6 includes the apparatus of example 1, wherein the service catalog datastore is to store a catalog including the workflow, and the processor circuitry is to perform at least one of the first operations, the second operations, or the third operations to instantiate broker service circuitry to host the catalog via the user interface to make the catalog accessible to a requesting entity.

Example 7 includes the apparatus of example 1, wherein the workflow includes custom logic defined by an entity associated with an enterprise, the approving entity associated with the enterprise.

Example 8 includes a non-transitory computer readable medium comprising instruction which, when executed, cause processor circuitry to monitor a status of a workflow, the workflow executed by an orchestrator, in response to the status indicating that the workflow requires a manual user interaction (MUI) to continue execution, cause a user interface to provide an approving entity with access to an MUI form associated with the MUI, record one or more responses to the MUI form from the approving entity, and send the one or more responses to the orchestrator to enable the orchestrator to continue execution of the workflow.

Example 9 includes the non-transitory computer readable medium of example 8, wherein the instructions, when executed, cause the processor circuitry to access, from a requesting entity, a request for the workflow, identify a cloud service provider associated with the request, and send the request and the workflow to an application programming interface (API) of the orchestrator, the API associated with the cloud service provider.

Example 10 includes the non-transitory computer readable medium of example 8, wherein the instructions, when executed, cause the processor circuitry to, in response to the status indicating that the workflow requires the MUI to continue execution, cause the user interface to provide an updated status to a requesting entity that requested the workflow.

Example 11 includes the non-transitory computer readable medium of example 8, wherein the approving entity is included in a predefined group of approving entities, and the instructions, when executed, cause the processor circuitry to, in response to the status indicating that the workflow requires the MUI to continue execution, cause the user interface to provide the predefined group of approving entities with access to the MUI form associated with the MUI.

Example 12 includes the non-transitory computer readable medium of example 8, wherein the instructions, when executed, cause the processor circuitry to request the status of the workflow periodically.

Example 13 includes the non-transitory computer readable medium of example 8, wherein the instructions, when executed, cause the processor circuitry to host a catalog via the user interface to make the catalog accessible to a requesting entity, the catalog including the workflow.

Example 14 includes the non-transitory computer readable medium of example 8, wherein the workflow includes custom logic defined by an entity associated with an enterprise, the approving entity associated with the enterprise.

Example 15 includes a method to enable manual user interaction (MUI) with automated processes, the method comprising monitoring, by executing an instruction with a processor, a status of a workflow, the workflow executed by an orchestrator, in response to the status indicating that the workflow requires an MUI to continue execution, causing, by executing an instruction with the processor, a user interface to provide an approving entity with access to an MUI form associated with the MUI, recording, by executing an instruction with the processor, one or more responses to the MUI form from the approving entity, and sending, by executing an instruction with the processor, the one or more responses to the orchestrator to enable the orchestrator to continue execution of the workflow.

Example 16 includes the method of example 15, further including accessing, from a requesting entity, a request for the workflow, identifying a cloud service provider associated with the request, and sending the request and the workflow to an application programming interface (API) of the orchestrator, the API associated with the cloud service provider.

Example 17 includes the method of example 15, further including, in response to the status indicating that the workflow requires the MUI to continue execution, causing the user interface to provide an updated status to a requesting entity that requested the workflow.

Example 18 includes the method of example 15, wherein the approving entity is included in a predefined group of approving entities, and the method further includes, in response to the status indicating that the workflow requires the MUI to continue execution, causing the user interface to provide the predefined group of approving entities with access to the MUI form associated with the MUI.

Example 19 includes the method of example 15, further including requesting the status of the workflow periodically.

Example 20 includes the method of example 15, further including hosting a catalog via the user interface to make the catalog accessible to a requesting entity, the catalog including the workflow.

Example 21 includes the method of example 15, wherein the workflow includes custom logic defined by an entity associated with an enterprise, the approving entity associated with the enterprise.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to enable manual user interaction (MUI) with automated processes, the apparatus comprising:
a service catalog datastore including a workflow; and
processor circuitry including one or more of:
at least one of a central processor unit (CPU), a graphics processor unit (GPU), or a digital signal processor (DSP), the at least one of the CPU, the GPU, or the DSP having control circuitry to control data movement within the processor circuitry, arithmetic and logic circuitry to perform one or more first operations corresponding to instructions, and one or more registers to store a first result of the one or more first operations, the instructions in the apparatus;
a Field Programmable Gate Array (FPGA), the FPGA including first logic gate circuitry, a plurality of configurable interconnections, and storage circuitry, the first logic gate circuitry and interconnections to perform one or more second operations, the storage circuitry to store a second result of the one or more second operations; or
Application Specific Integrated Circuitry (ASIC) including second logic gate circuitry to perform one or more third operations;
the processor circuitry to perform at least one of the first operations, the second operations, or the third operations to instantiate:
blueprint service circuitry to monitor a status of the workflow, the workflow executed by an orchestrator;
MUI form service circuitry to:
in response to the status indicating that the workflow requires an MUI to continue execution, cause a user interface to provide an approving entity with access to an MUI form associated with the MUI; and
record one or more responses to the MUI form from the approving entity; and
orchestrator gateway service circuitry to send the one or more responses to the orchestrator to enable the orchestrator to continue execution of the workflow.

2. The apparatus of claim 1, wherein the processor circuitry is to perform at least one of the first operations, the second operations, or the third operations to instantiate broker service circuitry to access, from a requesting entity, a request for the workflow, wherein:
the blueprint service circuitry is to identify a cloud service provider associated with the request; and
the orchestrator gateway service circuitry is to send the request and the workflow to an application programming interface (API) of the orchestrator, the API associated with the cloud service provider.

3. The apparatus of claim 1, wherein the processor circuitry is to perform at least one of the first operations, the second operations, or the third operations to instantiate the blueprint service circuitry to, in response to the status indicating that the workflow requires the MUI to continue execution, cause the user interface to provide an updated status to a requesting entity that requested the workflow.

4. The apparatus of claim 1, wherein the approving entity is included in a predefined group of approving entities, and the processor circuitry is to perform at least one of the first operations, the second operations, or the third operations to instantiate the MUI form service circuitry to, in response to the status indicating that the workflow requires the MUI to continue execution, cause the user interface to provide the predefined group of approving entities with access to the MUI form associated with the MUI.

5. The apparatus of claim 1, wherein the processor circuitry is to perform at least one of the first operations, the second operations, or the third operations to instantiate the blueprint service circuitry to request the status of the workflow periodically.

6. The apparatus of claim 1, wherein the service catalog datastore is to store a catalog including the workflow, and the processor circuitry is to perform at least one of the first operations, the second operations, or the third operations to instantiate broker service circuitry to host the catalog via the user interface to make the catalog accessible to a requesting entity.

7. The apparatus of claim 1, wherein the workflow includes custom logic defined by an entity associated with an enterprise, the approving entity associated with the enterprise.

8. A non-transitory computer readable medium comprising instruction which, when executed, cause processor circuitry to:
monitor a status of a workflow, the workflow executed by an orchestrator;
in response to the status indicating that the workflow requires a manual user interaction (MUI) to continue execution, cause a user interface to provide an approving entity with access to an MUI form associated with the MUI;
record one or more responses to the MUI form from the approving entity; and
send the one or more responses to the orchestrator to enable the orchestrator to continue execution of the workflow.

9. The non-transitory computer readable medium of claim 8, wherein the instructions, when executed, cause the processor circuitry to:
access, from a requesting entity, a request for the workflow;
identify a cloud service provider associated with the request; and
send the request and the workflow to an application programming interface (API) of the orchestrator, the API associated with the cloud service provider.

10. The non-transitory computer readable medium of claim 8, wherein the instructions, when executed, cause the processor circuitry to, in response to the status indicating that the workflow requires the MUI to continue execution, cause the user interface to provide an updated status to a requesting entity that requested the workflow.

11. The non-transitory computer readable medium of claim 8, wherein the approving entity is included in a predefined group of approving entities, and the instructions, when executed, cause the processor circuitry to, in response to the status indicating that the workflow requires the MUI to continue execution, cause the user interface to provide the predefined group of approving entities with access to the MUI form associated with the MUI.

12. The non-transitory computer readable medium of claim 8, wherein the instructions, when executed, cause the processor circuitry to request the status of the workflow periodically.

13. The non-transitory computer readable medium of claim 8, wherein the instructions, when executed, cause the processor circuitry to host a catalog via the user interface to make the catalog accessible to a requesting entity, the catalog including the workflow.

14. The non-transitory computer readable medium of claim 8, wherein the workflow includes custom logic defined by an entity associated with an enterprise, the approving entity associated with the enterprise.

15. A method to enable manual user interaction (MUI) with automated processes, the method comprising:
monitoring, by executing an instruction with a processor, a status of a workflow, the workflow executed by an orchestrator;
in response to the status indicating that the workflow requires an MUI to continue execution, causing, by executing an instruction with the processor, a user interface to provide an approving entity with access to an MUI form associated with the MUI;
recording, by executing an instruction with the processor, one or more responses to the MUI form from the approving entity; and
sending, by executing an instruction with the processor, the one or more responses to the orchestrator to enable the orchestrator to continue execution of the workflow.

16. The method of claim 15, further including:
accessing, from a requesting entity, a request for the workflow;
identifying a cloud service provider associated with the request; and
sending the request and the workflow to an application programming interface (API) of the orchestrator, the API associated with the cloud service provider.

17. The method of claim 15, further including, in response to the status indicating that the workflow requires the MUI to continue execution, causing the user interface to provide an updated status to a requesting entity that requested the workflow.

18. The method of claim 15, wherein the approving entity is included in a predefined group of approving entities, and the method further includes, in response to the status indicating that the workflow requires the MUI to continue execution, causing the user interface to provide the predefined group of approving entities with access to the MUI form associated with the MUI.

19. The method of claim 15, further including requesting the status of the workflow periodically.

20. The method of claim 15, further including hosting a catalog via the user interface to make the catalog accessible to a requesting entity, the catalog including the workflow.

21. The method of claim 15, wherein the workflow includes custom logic defined by an entity associated with an enterprise, the approving entity associated with the enterprise.
